(19) United States
(12) Patent Application Publication
(10) Pub. No.: US 2024/0151474 A1
(43) Pub. Date: May 9, 2024

(54) SURFACE HEAT EXCHANGER HAVING ADDITIONAL OUTLETS

(71) Applicant: SAFRAN, Paris (FR)

(72) Inventors: Ephraïm TOUBIANA, MOISSY-CRAMAYEL (FR); Samer MAALOUF, MOISSY-CRAMAYEL (FR); Quentin HOLKA, MOISSY-CRAMAYEL (FR)

(73) Assignee: SAFRAN, Paris (FR)

(21) Appl. No.: 18/548,780

(22) PCT Filed: Mar. 6, 2022
(86) PCT No.: PCT/FR2022/050397

§ 371 Date: Sep. 1, 2023

(30) Foreign Application Priority Data
Mar. 9, 2021 (FR) FR2102270

(51) Int. Cl. F28D 1/053; F28F 1/32

(52) U.S. Cl. CPC F28D 1/05391; F28F 1/325; F28D 2021/0021

(57) ABSTRACT

A surface heat exchanger for an aircraft turbomachine includes a support wall, a panel parallel to the support wall, partitions connecting the wall to the panel to define channels in which an air flow flows, and fins situated in the channels. The panel has a central part parallel to the wall and a downstream part that is inclined with respect to the wall. An upstream end is connected to the central part and a downstream end is situated at a distance from the wall and delimits with the latter a main outlet of the channels. The downstream part has fixed flaps disposed one after another so as to delimit between one another additional outlets of the channels.

### TECHNICAL FIELD OF THE INVENTION

The present invention relates to the general field of the aeronautic. It is aimed in particular at a surface heat exchanger for a turbomachine, as well as a turbomachine comprising such a heat exchanger.

### TECHNICAL BACKGROUND

A turbomachine, in particular for an aircraft, comprises various members and/or items of equipment that need to be lubricated and/or cooled, such as rolling bearings and gears. The heat released by these components, which can be very high depending on the power of the member and/or the item of equipment, is transported by a fluid and evacuated towards cold sources available in the aircraft.

It is known to equip the turbomachine with one or more heat exchange systems to carry out the heat exchange between the lubricating fluid (typically oil) and the cold source (air, fuel, etc). There are even different types of heat exchange systems, such as for example the fuel/oil heat exchangers, generally known by the acronym FCOC (Fuel Cooled Oil Cooler) and the air/oil heat exchangers, known by the acronym ACOC (Air-Cooled Oil Cooler).

The FCOC heat exchangers have a dual function of heating the fuel before the combustion in the combustion chamber of the turbomachine and cooling the oil heated by the thermal dissipations of the turbomachine. However, the FCOC heat exchangers are not sufficient to absorb all the thermal dissipations because the temperature of the fuel is limited for safety reasons.

The additional cooling is obtained by the ACOC heat exchangers, in particular those of the surface type known by the acronym SACOC. The surface heat exchangers are usually located in the secondary duct of the turbomachine and use the secondary air flow to cool the oil circulating in the turbomachine. These heat exchangers are in the form of a metallic surface piece allowing the passage of oil in channels. The secondary air flow is guided along fins carried by this surface piece and which have the role of increasing the contact surface with the secondary air flow and extracting the calories. However, the disadvantage of the SACOC heat exchangers is that they create additional pressure losses in the relevant secondary duct, since they disturb the air flow, which has an impact on the performance of the turbomachine as well as on the specific fuel consumption.

Their aerothermal performance (ratio between the thermal power dissipated and the pressure loss induced on the side of the secondary air flow) is low.

In addition, the cooling requirements of the lubricating fluid are increasing due to the higher rotational speeds and the power requirements to meet the specification trends on the turbomachines.

Heat exchange systems such as those described in FR-A1-3 096 444 and FR-A1-3 096 409 are known, in which the flow conditions are modified allowing to ensure a heat dissipation with an optimum aerothermal performance, thereby helping to reduce pressure losses. These heat exchange systems, when installed in the secondary duct of a turbomachine, comprise profiled upstream and downstream walls that allow better control of the flow speed of the air flow entering and leaving the heat exchanger. More specifically, the upstream wall has a divergent profile allowing to slow down the air flow entering a heat exchange space of the heat exchanger and the downstream wall has a convergent profile allowing to accelerate the air flow leaving the heat exchanger.

However, the “convergent” profile of the wall at the heat exchanger outlet can still cause the part of the air flow bypassing the heat exchanger, i.e. the air flow that does not pass through it, to become a turbulent air flow in a flow recirculation area. The profile of the wall at the exchanger outlet can be modified to make it less “convergent”. However, the overall length of the heat exchanger is constrained by the dimensions of the secondary duct in which it is installed. A reduction in the convergence of the outlet wall leads on the one hand to a reduction in the central space of the heat exchanger penalising the heat exchanges and on the other hand to a premature acceleration of the outlet air flow penalising the drag of the surface heat exchanger.

### SUMMARY OF THE INVENTION

The aim of the present invention is to overcome this disadvantage by providing a surface heat exchanger that allows better control of the air flow leaving the exchanger.

To this end, the invention relates to a surface heat exchanger for an aircraft turbomachine comprising:
a support wall,
a panel arranged substantially parallel to the support wall,
partitions configured to connect the support wall to the panel in a direction perpendicular to said support wall, said partitions defining between them channels in which a first air flow flows, said partitions being substantially parallel to each other and to a first flow direction of said first air flow,
fins located in said channels and extending substantially parallel to each other and to said first flow direction, said fins being intended to be swept by said first air flow,
said panel comprising:
a central portion substantially parallel to said support wall and located at a first distance from said support wall,
a downstream portion having a general orientation inclined with respect to said support wall, said downstream portion comprising an upstream end connected to said central portion and a free downstream end located at a second distance from the support wall and delimiting a main outlet of the channels with the support wall, said second distance being less than said first distance.

According to the invention, said downstream portion comprises at least two stationary flaps arranged one behind the other from upstream to downstream and configured to delimit between them at least one additional outlet from said channels.

Thus, this solution allows to achieve the above-mentioned objective. In particular, the addition of additional outlets of the channels for the first air flow allows to compensate for excessive convergence of the downstream portion of the exchanger. The first air flow passing through an additional outlet located closer to the panel than the main outlet prevents the second air flow from bypassing the heat exchanger. Increasing the number of additional outlets also allows the first air flow to flow through the surface heat exchanger at a uniform speed over its entire height.

The surface heat exchanger may also have one or more of the following characteristics, taken alone or in combination with each other:
the number of flaps is between two and five,
each of said flaps extends in a plane inclined at a predetermined angle with respect to said support wall,
the value of the predetermined angles of said flaps decreases from said central portion to said main outlet,
the value of each of said angles of the flaps is between 5° and 45°,
the or each additional outlet is defined by a height whose value is less than or equal to said second distance,
the or each radial height and the second radial distance each represent between 5% and 60% of said first distance,
each of said flaps is connected to said support wall by at least a portion of said fins and/or by a support element rising between the support wall and the flaps,
at least a portion of said flaps comprise a downstream edge located in the vicinity of an upstream edge of an adjacent flap, said upstream edges and downstream edges being arranged substantially in the same plane perpendicular to said support wall,
the surface heat exchanger is produced by additive manufacturing,
the surface heat exchanger is machined and/or brazed.

The invention also relates to a turbomachine comprising at least one surface heat exchanger having any of the preceding characteristics.

### BRIEF DESCRIPTION OF THE FIGURES

Further characteristics and advantages of the invention will become apparent from the following detailed description, for the understanding of which reference is made to the attached drawings in which:

FIG. 1 is an axial cross-sectional view of an example of turbomachine to which the invention applies;

FIG. 2 is a perspective view of an embodiment of a surface heat exchanger;

FIG. 3 shows a partial view of a heat exchanger comprising a panel covering fins;

FIG. 4 is a perspective view of the heat exchanger of FIG. 3 without the central portion of the panel;

FIG. 5 is an axial cross-sectional view of an embodiment of a heat exchange system according to the invention;

FIG. 6 shows an axial cross-section of a surface heat exchanger according to the invention; and

FIG. 7 is an axial cross-sectional view of a portion of the heat exchanger of FIG. 6 according to the invention.

### DETAILED DESCRIPTION OF THE INVENTION

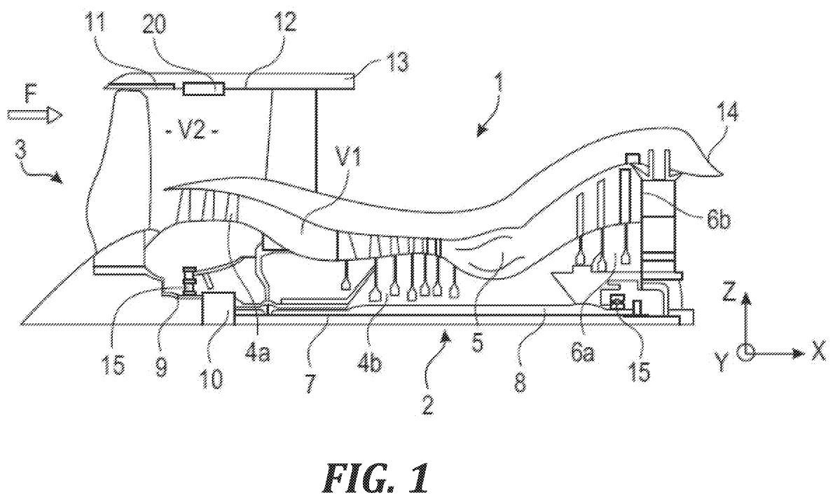

FIG. 1 shows an axial cross-sectional view of a turbomachine of longitudinal axis X to which the invention applies. The turbomachine shown is a double-flow turbomachine 1 intended to be mounted on an aircraft. Of course, the invention is not limited to this type of turbomachine.

This double-flow turbomachine 1 generally comprises a gas generator 2 upstream of which is mounted a fan or fan module 3.

In the present invention, the terms “upstream” and “downstream” are used in reference to a position relative to a flow axis of the gases in the turbomachine 1 and here along the longitudinal axis X-X. “Longitudinal” or “longitudinally” means any direction parallel to the longitudinal axis X-X.

The gas generator 2 comprises a gas compressor assembly (here comprising a low pressure compressor 4a and a high pressure compressor 4b), a combustion chamber 5 and a turbine assembly (here comprising a high pressure turbine 6a and a low pressure turbine 6b). Typically the turbomachine comprises a low pressure shaft 7 which connects the low pressure compressor and the low pressure turbine to form a low pressure body and a high pressure shaft 8 which connects the high pressure compressor and the high pressure turbine to form a high pressure body. The low-pressure shaft 7, centred on the longitudinal axis, drives here a fan shaft 9 by means of a gearbox 10. Rotational guide bearings are also used to guide the low-pressure shaft 7 in rotation relative to a stationary structure of the turbomachine.

The fan 3 is shrouded by a fan casing 11 carried by a nacelle 12 and generates a primary air flow which circulates through the gas generator 2 in a primary duct V1 and a secondary air flow which circulates in a secondary duct V2 around the gas generator 2. The secondary air flow V2 is ejected by a secondary nozzle 13 terminating the nacelle, while the primary air flow is ejected outside the turbomachine via an ejection nozzle 14 located downstream of the gas generator 2. In the following, the fan casing and the nacelle are considered as one piece.

The guide bearings 15 and the gearbox 10 in this example of configuration of the turbomachine must be lubricated and/or cooled to ensure the performance of the turbomachine. The power generated by these is dissipated in a fluid from a fluid supply source installed in the turbomachine, which allows to lubricate and/or cool various members and/or items of equipment of the turbomachine. Of course, other items of equipment of the turbomachine generates a lot of heat that must be extracted from its environment.

To this end, the turbomachine 1 comprises a surface heat exchanger 20 (hereinafter “exchanger 20”) which is arranged in the fan casing 11. The heat exchanger 20 is used to cool the fluid intended to lubricate and/or cool these members and/or items of equipment. In this example, the fluid is an oil and the cold source intended for cooling the oil is the air flow circulating in the turbomachine 1.

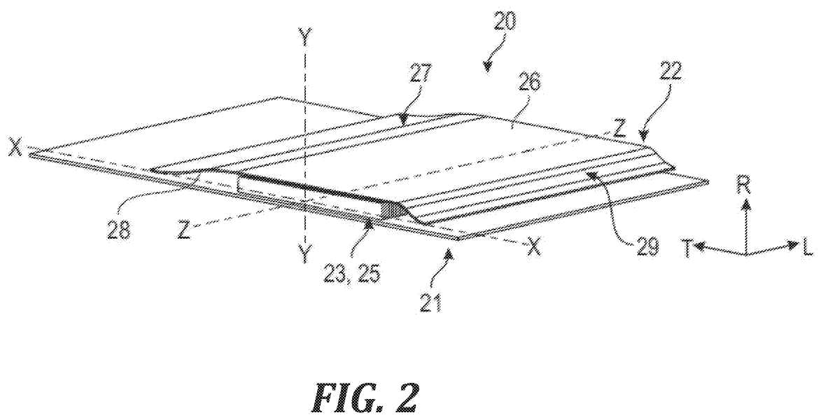

With reference to FIGS. 2 to 7, the exchanger 20 comprises a support wall 21 which extends in a longitudinal direction L parallel to the longitudinal axis X-X. The support wall 21 is substantially flat. This support wall 21 may not be completely flat but curved to follow the profile of the wall of the fan casing 11 which is intended to carry the heat exchanger 20 and which is substantially cylindrical (of longitudinal axis X-X). The heat exchanger 20 can occupy the entire wall of the fan casing 11 or be arranged on a segment of it.

The exchanger 20 also comprises a panel 22 which extends along the longitudinal direction L for a predetermined length. The panel 22 is arranged substantially parallel to the support wall 21. The panel 22 is arranged above or below the support wall 21. In the remainder of the description, the terms “above/external” and “below/internal” are used with reference to a positioning in relation to the plane in which the support wall 21 is arranged, in this case the plane XY comprising the longitudinal axis X-X and a transverse axis Y-Y perpendicular to the longitudinal axis X-X. “Transverse” or “transversely” means any direction parallel to the transverse axis Y-Y and “radial” or “radially” means any direction perpendicular to the plane XY.

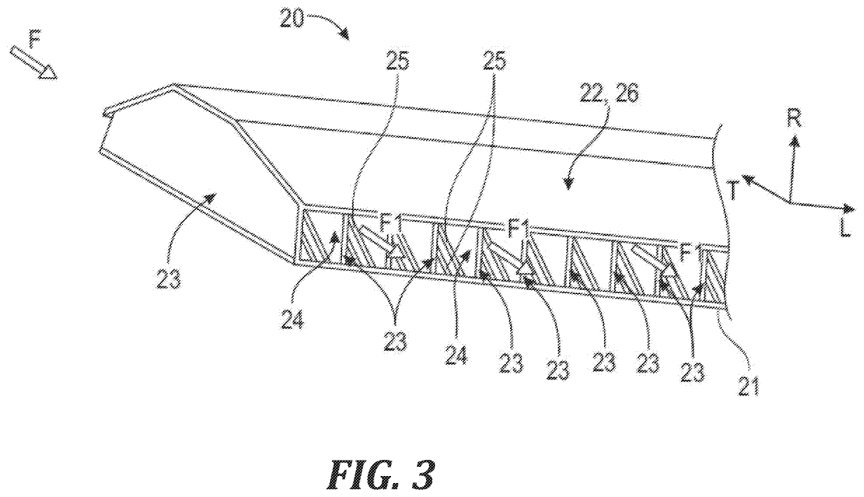

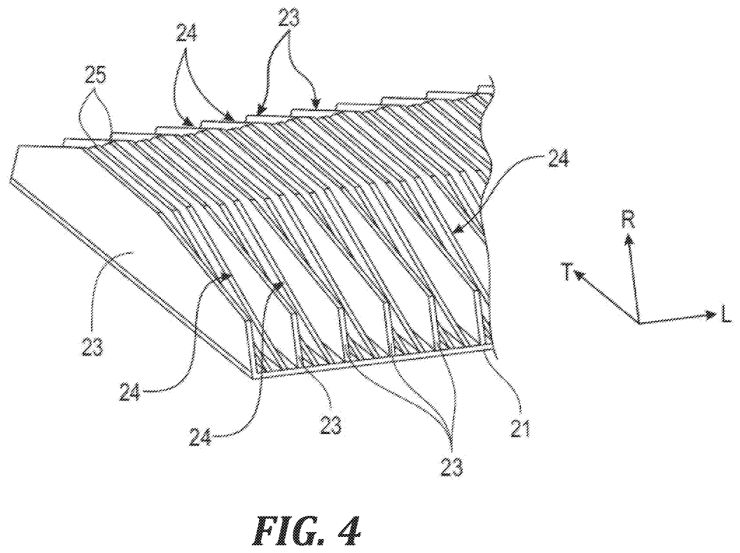

As shown in FIGS. 3 and 4, the panel 22 and the support wall 21 are connected together by partitions 23. Each of these partitions 23 rises from the support wall 21 to the panel 22 in a radial direction R and extends in the longitudinal direction L. The partitions 23 are flat, although they may have a curved shape. The partitions 23 are arranged in regular succession along a transverse direction T. They are arranged parallel to one another to define between them a succession of straight channels 24 through which a first air flow F1 flows. This first air flow F1 corresponds to a portion of the secondary air flow F entering the secondary duct V2 and passing through the exchanger 20. The channels 24 formed by the partitions 23 are oriented in a first direction of flow of the air flow F1. This flow direction corresponds to the longitudinal direction L.

The heat exchanger 20 also comprises fins 25 which are arranged in the channels 24 so that they are swept by the air flow F1. The fins 25 are preferably straight and flat, although they may be curved. They may also have a discontinuous external edge in the longitudinal direction L, as shown in FIGS. 3 and 4. Each of the fins 25 rises in the radial direction R and extends in the direction of flow of the air flow F1. More specifically, the fins 25 are arranged parallel to each other and to the partitions 23 and evenly in each of the channels 24 along the transverse direction T.

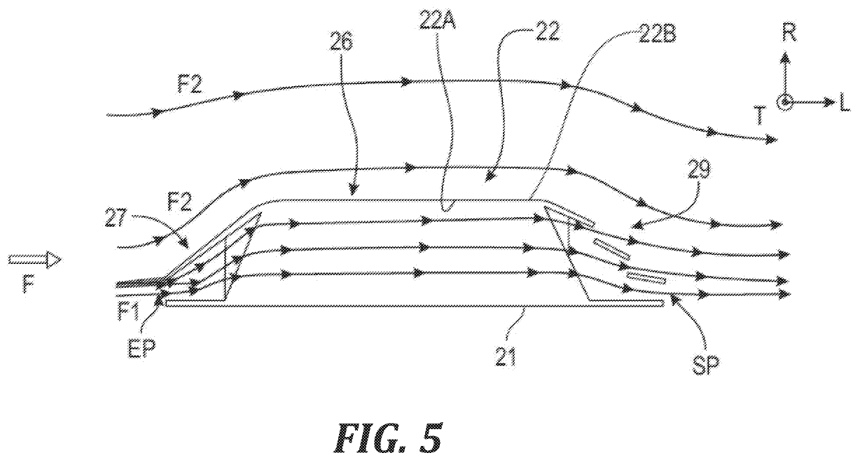

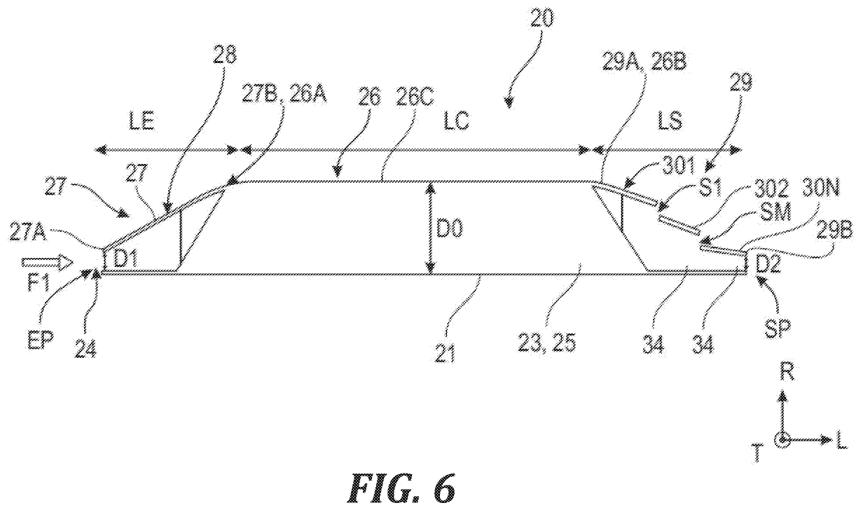

Referring to FIGS. 5 and 6, the panel 22 comprises an internal surface 22A and an external surface 22B. The internal surface 22A faces the support wall 21 so that it is also swept by the air flow F1 entering the exchanger 20. The external surface 22B is swept by a second air flow F2. This second air flow F2 corresponds to the portion of the secondary air flow F entering the secondary duct V2 and bypassing the exchanger 20. The air flow F2 flows over the external surface 22B in a direction generally parallel to the longitudinal direction L.

In a preferred embodiment, the panel 22 comprises a central portion 26. The central portion 26 extends in a plane substantially parallel to the XY plane above the support wall 21 over a central length LC which may be less than or equal to the length of the fins 25. In particular, it is located at a first predetermined distance D0 from the support wall 21 in the radial direction R, as shown in FIG. 6. In addition, the central portion 26 extends along the transverse direction T over a width at least equal to the width over which the partitions 23 are arranged. Alternatively, the central portion 26 can be inclined relative to the support wall 21 so that the panel 22 has at least partly a curved aerodynamic profile. The distance D0 between the central portion 26 and the support wall 21 can then vary along the longitudinal direction L (see FIGS. 3 and 4).

As shown in FIGS. 5 and 6 in particular, the panel 22 also comprises an upstream portion 27 which is located on the side of a main inlet EP of the channels 24 of the exchanger 20 (in the circulation orientation of the secondary air flow F). It comprises a wall 28 with a divergent profile to guide and slow down the air flow F1 entering the channels 24. More particularly, the profile of the wall 28 is substantially corrugated or curved in a plane defined by the longitudinal L and radial R directions. The upstream portion 27 may cover a downstream portion of the fins 25 (not shown) and extends over an inlet length LE which is less than the length LC of the central portion 26.

The upstream portion 27 also comprises a free upstream end 27A which delimits the main inlet EP of the channels 24 with the support wall 21. This main inlet EP is defined by a predetermined inlet distance D1 in the radial direction R. The value of the inlet distance D1 is preferably less than the distance D0 so that the air flow F1 is slowed down on entering the channels 24. The upstream portion 27 also comprises a downstream end 27B opposite the free upstream end 27A, as shown in FIG. 6. This downstream end 27B connects the upstream portion 27 to an upstream edge 26A of the central portion 26. The external surface 27C of the upstream portion 27 has a continuous surface with the external surface 26C of the central portion 26.

With reference to FIG. 6, the panel 22 further comprises a downstream portion 29 which is located on the side of a main outlet SP of the channels 24 of the exchanger 20 (in the circulation orientation of the air flow F1) and which extends over an outlet length LS in the longitudinal direction L. This length LS is less than the length LC of the central portion 26. This downstream portion 29 is configured to guide and accelerate the air flow F1 leaving the channels 24 of the exchanger 20. It is arranged in a plane extending along the transverse direction T over a width comparable to the width over which the upstream portion 27 and the central portion 26 extend and can cover a downstream portion of the fins 25 (not shown). The downstream portion 29 has an angular orientation generally inclined with respect to the plane XY in which the support wall 21 is arranged so as to form a generally decreasing profile from the central portion 26 towards the support wall 21 (in the circulation orientation of the air flow F1). The downstream portion 29 is provided with an upstream end 29A which connects it to a downstream edge 26B of the central portion 26 and a downstream end 29B which is a free end opposite the upstream end 29A. The downstream end 29B is separated from the support wall 21 by a second predetermined distance D2, referred to as the outlet distance. This outlet distance D2 defines the main outlet SP of the channels 24 through which the air flow F1 flows. The value of the distance D2 is less than the value of the distance D0, both measured in the radial direction R. The value of the distance D2 is between 5% and 60% of the value of the distance D0.

The central 26, upstream 27 and downstream 29 portions of the panel 22 are made in a single piece, for example using an additive manufacturing (or 3D printing) method such as a selective melting method on a powder bed.

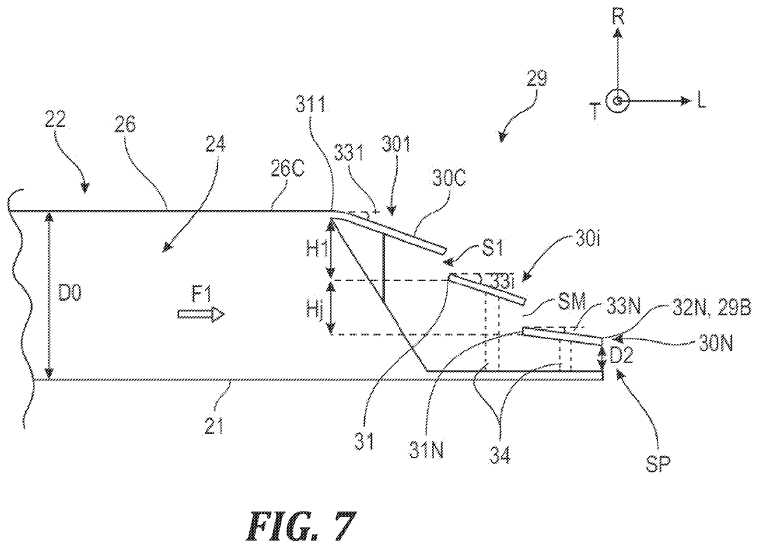

In a preferred embodiment, the downstream portion 29 also comprises stationary flaps 30i, with i=1, etc., N where N is an integer representing the maximum number of stationary flaps 30i. As shown in FIGS. 6 and 7, these flaps 30i are arranged from upstream to downstream one behind the other from the panel 22 towards the support wall 21 so that the downstream portion 29 has a generally convergent profile. The arrangement of two adjacent flaps 30i delimits an additional outlet Sj of the channels 24, j=1, etc., M where M is an integer representing the maximum number of additional outlets.

The downstream portion 29 comprises a number N of flaps 30i of between two and five, and preferably between three and five, so that the number M of additional outlets Sj is between 1 and four, and preferably between two and four. Each of the flaps 30i has an upstream edge 31i and a downstream edge 32i opposite the upstream edge 31i. Depending on the number N of flaps 30i, the downstream portion 29 comprises at least one external flap 301 and one internal flap 30N, as shown in FIG. 7. More particularly, the external flap 301 is arranged upstream of any other flap 30i so that its upstream edge 311 represents the upstream end 29A of the downstream portion 29 which connects it to the central portion 26. The external flap 301 comprises an external surface 30C which has a surface continuity with the external surface 26C of the central portion 26. The internal flap 30N is arranged downstream of any other flap 30i so that its downstream edge 32N represents the free downstream end 29B of the downstream portion 29 which delimits the main outlet SP of the channels 24 with the support wall 21.

In addition, the flaps 30i are arranged in a direction opposite to the radial direction R so that the downstream edge 32i of a flap 30i is located in the vicinity of the upstream edge 31i of an adjacent flap 30i. More particularly, the upstream 31i and downstream 32i edges of adjacent flaps 30i are arranged substantially in the same plane perpendicular to said support wall 21 in the radial direction R, as shown in FIG. 7.

In a preferred embodiment, each of the flaps 30i is arranged in a plane which extends in the transverse direction T over a width at least equal to the width over which the channels 24 are arranged.

As shown in FIG. 7, each of the flaps 30i is inclined at a predetermined angle 33i with respect to the support wall 21. The value of each of the predetermined angles 33i can vary between 0° and 45°. The value of the angles 33i of two adjacent flaps defines an opening of the additional outlet Sj. More particularly, when the value of the angle 33i of the upstream flap 30i (in the orientation of circulation or flow of the air flow F1) is close to 0°, this flap 30i is arranged in a plane substantially parallel to that of the support wall 21. Opening the additional outlet Sj allows to reduce the flow of the air flow F1. Conversely, when the value of the angle 33i of the upstream flap 30i is close to 45°, the opening of the additional outlet Sj is increased, as is the flow of the air flow F1. Preferably, the value of each of the predetermined angles 33i is between 5° and 30°.

In addition, the angles 33i of the flaps 30i can have different values so that the additional outlets Sj can have different openings along the downstream portion 29.

In a preferred embodiment, the value of the predetermined angles 33i of the flaps 30i decreases along the longitudinal direction L from the central portion 26 of the panel 22 to the main outlet SP of the channels 24. The external flap 301 then has an angle 331 small enough to prevent the air flow F2 from becoming detached downstream of the central portion 26 of the panel 22.

In addition, the presence of several adjacent flaps 30i allows that the downstream portion 29 is not lengthened, which would reduce the length LC of the central portion 26, thus penalising the heat exchange between the air flow F1 and the oil.

In one variant, the angles 33i of the flaps 30i all have identical values. The flaps 30i are all arranged in planes parallel to each other.

As shown in FIG. 7, the distance between the upstream edges 31i of two adjacent flaps defines a height Hj of additional outlet Sj. The values of the heights Hj may be different or identical to each other. On the other hand, all the values of the heights Hj are less than or equal to the value of the distance D2 defining the main outlet of the channels 24.

In addition, each height Hj of additional outlet represents between 5% and 60% of the distance D0.

The exchanger 20 also comprises support elements 34 allowing for connecting the flaps 30i to the support wall 21. Each support element 34 rises from the support wall 21 in the radial direction, in line with a flap 30i. The number of support elements 34 can therefore be equal to the number N of flaps 30i of the downstream portion 29. As the flaps 30i are inclined relative to the support wall 21, the support elements 34 have a substantially trapezoidal shape. In a particular embodiment, some flaps 30i, including the external flap 301, are connected to the support wall 21 by the downstream portion of the fins 25. In this example of embodiment, the number of support elements 34 is less than the number N of flaps 30i. The support elements 34 may be thicker than the fins 25. The fins 25, the partitions 23 and the support elements 34 can each be attached to the support wall 21 by brazing independently of each other or together. Alternatively, the fins 25, the partitions 23 and the support elements 34 can form a single monobloc piece with the support wall 21. Of course, the exchanger 20 as a whole can be manufactured by any other manufacturing method, such as machining, forging or brazing.

The heat exchanger 20 according to the invention has the particular advantage of homogenising the flow or circulation speed of the air flow F1 over the entire distance D0.

In addition, the presence of several stationary flaps with different angular orientations allows to eliminate the recirculation area of the air flow F2 which bypasses the heat exchanger without increasing the outlet length LS. This reduces the drag induced by the heat exchanger.

1. A surface heat exchanger for an aircraft turbomachine, the heat exchanger comprising:
a support wall,
a panel arranged parallel to the support wall,
partitions configured to connect the support wall to the panel in a direction perpendicular to said support wall, said partitions defining therebetween channels in which a first air flow flows, said partitions being parallel to each other and to a first flow direction of said first air flow, and
fins located in said channels and extending parallel to each other and to said first flow direction, said fins being configured to be swept by said first air flow,
said panel comprising:
a central portion parallel to said support wall and located at a first distance from said support wall, and
a downstream portion having an orientation inclined with respect to said support wall, said downstream portion comprising an upstream end connected to said central portion and a free downstream end located at a second distance from the support wall and delimiting a main outlet of the channels with the support wall, said second distance being less than said first distance,
said downstream portion comprising at least two stationary flaps arranged one behind the other from upstream to downstream and configured to delimit between them at least one additional outlet from said channels.

2. The heat exchanger according to the claim 1, wherein a number of flaps is between two and five.

3. The heat exchanger according to claim 1, wherein each of said flaps extends in a plane inclined at a predetermined angle with respect to said support wall.

4. The heat exchanger of claim 1, wherein a value of the predetermined angles of said flaps decreases from said central portion to said main outlet.

5. The heat exchanger according to claim 3, wherein a value of each of said angles of the flaps is between 0° and 45°.

6. The heat exchanger according to claim 1, wherein the or each additional outlet is defined by a height whose value is less than or equal to said second distance.

7. The heat exchanger claim 6, wherein the or each height and the second distance each represents between 5% and 60% of said first distance.

8. The heat exchanger according to claim 1, wherein each of said flaps is connected to said support wall by at least a portion of said fins and/or by a support element rising between the support wall and the flaps.

9. The heat exchanger according to claim 1, wherein at least a portion of said flaps comprise a downstream edge located in a vicinity of an upstream edge of an adjacent flap, said upstream and downstream edges being arranged in a same plane perpendicular to said support wall.

10. An aircraft turbomachine comprising at least one heat exchanger according to claim 1.
